(19) United States
(12) Patent Application Publication
(10) Pub. No.: US 2015/0268383 A1
(43) Pub. Date: Sep. 24, 2015

(54) SYSTEMS AND METHODS FOR FORMING A LARGE-SCALE MOTHEYE FILM COATING ON A SUBSTRATE

(71) Applicant: Triton Systems, Inc., Chelmsford, MA (US)

(72) Inventors: Lawrence H. DOMASH, Conway, MA (US); Scott MORRISON, Chelmsford, MA (US); Arthur GAVRIN, Litchfield, NH (US); Ken MAHMUD, Sudbury, MA (US)

(73) Assignee: Triton Systems, Inc., Chelmsford, MA (US)

(21) Appl. No.: 14/212,148

(22) Filed: Mar. 14, 2014

Related U.S. Application Data
(60) Provisional application No. 61/793,278, filed on Mar. 15, 2013.

(51) Int. Cl. G02B 1/118; B31C 99/00; B05D 3/00; B05D 5/00; G02B 1/111; B05D 3/12

(52) U.S. Cl. CPC G02B 1/118; G02B 1/111; B05D 3/12; B05D 3/007; B05D 5/00; B31C 13/00; Y10S 977/782; B82Y 20/00

(57) ABSTRACT

Nanoimprinted films, devices including nanoimprinted films, methods for making such films, and devices and apparatuses for making such films are described herein. The nanoimprinted films can be used to provide an antireflective coating for windows, windshields, visors, lenses, and other devices.

### CROSS-REFERENCE TO RELATED APPLICATIONS

This application claims priority to U.S. Provisional No. 61/793,278, entitled “Systems and Methods for Forming a Large-Scale Moth Eye Film Coating on a Substrate” filed Mar. 15, 2013, the entire contents of which is hereby incorporated by reference.

### GOVERNMENT INTERESTS

This invention was made with Government support under Contract No. W152KN-12-C-0050, Contract No. W152KN-13-C-0039 and Grant No. SBIR A-11-134 awarded by the U.S. Army. The United States Government has certain rights in this invention.

### BACKGROUND

Glass optical lenses including eyeglasses, camera lenses, binoculars and the like are generally provided with antireflectance coatings to suppress stray light and reflections and improve throughput. Established commercial practice today is typically based on deposition of multi-layer thin films to accomplish antireflectance. However, thin film antireflectance has limitations, such as the loss of performance at large angles of incidence. It has been known for some time that a different approach to antireflectance treatment, nanostructured antireflectance, is intrinsically superior to thin films in providing lower reflectance over a broader range of wavelengths and a wider range of angles of incidence.

Optical substrates such as glass or the higher index materials such as Ge or Si display large surface reflectance losses (for Ge, (n−1/n+1)²≈36%) unless some type of surface anti-reflective treatment is applied. Established anti-reflective treatments include depositing multiple layers of high and low index films such as silicon monoxide, yttrium fluoride, or amorphous Ge on the substrate by electron-beam assisted evaporation, sputtering or CVD. Limitations on these methods have proven impossible to overcome.

Nanostructured anti-reflectives, which are based on submicron shapes such as pits or protuberances in the surface of the optic rather than thin films, is sometimes also called “moth-eye” because it has been discovered that certain insects evolved these structures naturally. However, moth-eye structures have not been widely applied to commercial optics production because of the difficulty of manufacturing and integrating them onto optics in a uniform, cost-efficient way.

### BRIEF DESCRIPTION OF THE DRAWINGS

FIGS. 1A-1D show cross-sectional views (1A and 1B) and perspective views (1C and 1D) of various shapes and sizes of nanoscale protuberances that may be used in a motheye pattern.

FIGS. 2A and 2B show two different stamping apparatuses for affixing a large nanoscale motheye pattern to a film.

FIG. 3 is a schematic diagram of an adhesion process of a motheye-imprinted film to a substrate.

FIG. 4 a flow diagram of a general process for fabricating an apparatus for reproducing a motheye nanopattern on a film at a large scale.

FIG. 5A is a schematic of a method of forming a master template containing a nanoscale motheye pattern, and FIG. 5B is an example of a sacrificial material mask having annular openings.

FIGS. 6A and 6B are schematic diagrams of a method of forming a master template of a nanoscale motheye pattern.

FIG. 7 is a schematic showing initiation, propagation and termination steps of a thiol-ene free-radical addition reaction used to form a polymer.

FIG. 8 is a schematic diagram showing replication of a silicon master template of a nanoscale motheye pattern.

FIG. 9 is a schematic diagram showing fabrication of a cylindrical drum tool for a large scale fabrication of a nanopatterned motheye film.

FIG. 10 is a graphical representation of reflectance of a motheye film-coated substrate.

FIG. 11A is a scanning electron microscopy measurement of a nickel master template.

FIG. 11B is an atomic force microscopy measurement of a nickel master template.

FIG. 12 is a scanning electron microscopy measurement of a motheye film.

FIGS. 13A and 13B are scanning electron micrographs of a motheye film.

FIG. 14 is a schematic diagram of a polymer that is cured while it remains in contact with a master template.

FIG. 15 is a graph showing the VIS-NIR reflectance measured from BK7 flat coated with multilayer thin film.

FIG. 16 is a graph showing the VIS-NIR reflectance measured from BK7 flat coating optimized for VIS only.

FIG. 17 is a graph showing the VIS-NIR reflectance measured from a Borofloat window with a single layer MgF₂ “V Coat.”

FIG. 18 is a graph showing reflectance of the broadband VIS-NIR coating corresponding to FIG. 15 measured at different angles.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

Embodiments of the invention are directed to films imprinted with a custom-formed motheye pattern and methods for making such films on a large scale. Other embodiments are directed to methods for applying such films to substrates including curved substrates such as windows, windshields, visors, glasses, lenses, or other optics, and antireflective coatings including motheye patterned films attached to the substrates such as windows, windshields, visors, glasses, lenses, or other optics.

Motheye patterns typically include periodic nanostructures that are etched into a substrate. These features approximate the effect of grating the refractive index from the substrate (n=1.5, plus or minus) to the air (n=1.0) by means of a subwavelength physical structures. The precise shape of these nanostructures, for example, the dimensions of their base and height, the shape and angle of the sides, and in general the fine details of the structure, are important for determining the antireflectance properties.

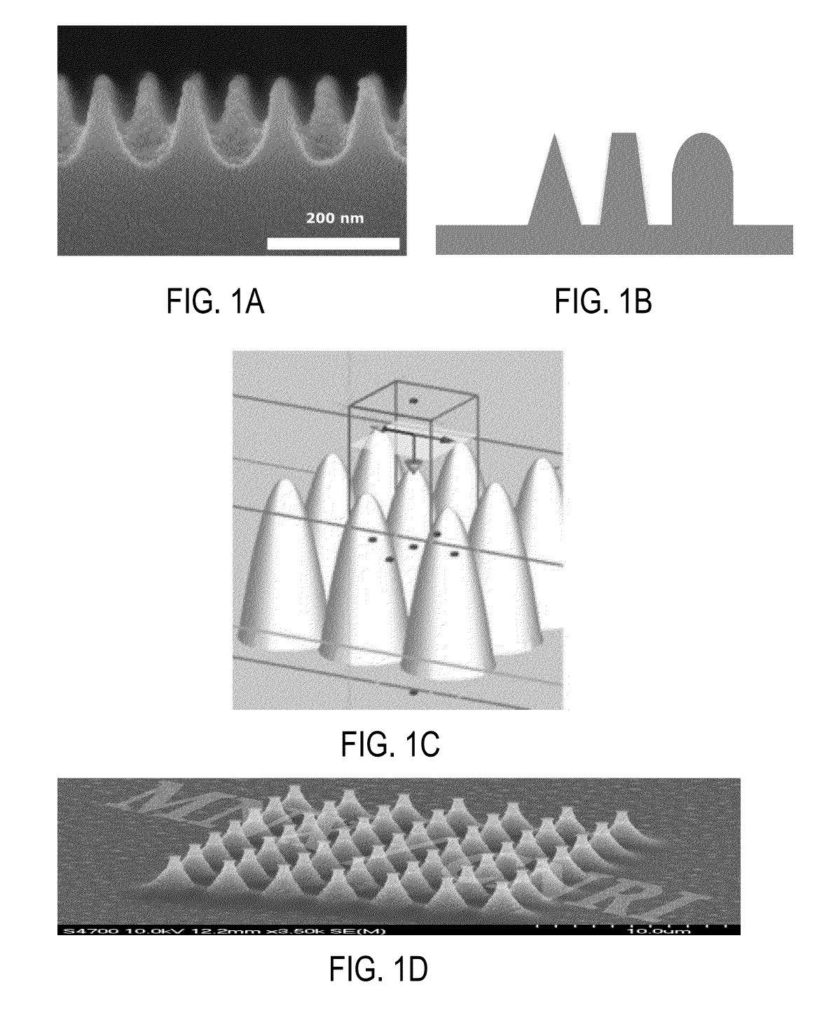

The films of various embodiments of the motheye films can have nanostructures of any shape such as, for example, generally conical shaped, pyramid shaped, trapezoidal shaped, truncated pyramid shaped, and the like, or combinations thereof, and some examples of these shapes in the context of the films of the invention are shown in FIGS. 1A-1D. These nanostructures generally protrude from an upper surface of the film, and when applied to a substrate, the nanostructures may extend away from the substrate, narrowing towards the top or air interface. In some embodiments, the nanostructures may have a height of about 10 nm to about 1000 nm, about 15 nm to about 750 nm, about 20 nm to about 500 nm, about 30 nm to about 300 nm, or any individual height or range encompassed by these example ranges. In certain embodiments in which the nanostructures are conical shaped, a circumferential base may have a radius of from about 10 nm to about 500 nm, about 25 nm to about 400 nm, about 50 nm to about 300 nm, or any individual radius or range encompassed by these example ranges. In embodiments in which the nanostructures are pyramidal and trapezoidal shaped having a square or a triangular base, the sides of the square or triangular base may be from about 10 nm to about 1000 nm, about 25 nm to about 750 nm, about 50 nm to about 500 nm, about 75 nm to about 400 nm, or any individual length or range encompassed by these example ranges.

The motheye films of some embodiments may include randomly arranged nanostructures. In certain embodiments, motheye films may include nanostructures that are arranged in a repeating pattern such as, for example, parallel rows, alternating rows, concentric squares, circular patterns, swirl patterns, or concentric circles. In some embodiments, two or more or three or more patterns of such patterns may be included in separate portions of the films, and in particular embodiments, such patterns may be applied on top of one another. In still other embodiments, portions of the films may be patterned in one design and other portions of the films may be patterned another design. Whether the nanostructures are randomly arranged, patterned, or combinations thereof, the nanostructures may be spaced from one another by a distance of about 10 nm to about 800 nm as measured from the geometric center of an individual nanostructure to the geometric center of a neighboring nanostructure. As such, the films of various embodiments may have a nanostructure pitch or lateral periodicity of about 1 nanostructure every 10 nm to about 500 nm, about 1 nanostructure every 100 nm to about 400 nm, about 1 nanostructure every 150 nm to about 300 nm, or any individual periodicity or range encompassed by these example ranges.

The aspect ratio of the nanostructures (i.e., the ratio of the height to the periodicity to the nanostructures) may be important for optimizing the performance of the anti-reflective coatings. In particular, motheye films having a large aspect ratio of greater than 2:1 height to periodicity provide reduced reflection over a broad range of angles of incidence, for example, from about 0° to about 80°, 0° to about 70°, 0° to about 60°, 0° to about 30°, or any range or individual value encompassing these ranges. In various embodiments, the aspect ratio of the nanostructures may be from about 2.5:1 to about 10:1, about 3:1 to about 8:1, about 3.5:1 to about 7:1, about 4:1 to about 6:1, or any range or individual aspect ratio encompassed by these ranges. In particular embodiments, the aspect ratio may be about 3:1.

The shape of the nanostructures may also impact the anti-reflective properties of the motheye films described above. For example, truncation of conical or pyramidal shaped nanostructures may cause a reduction in the anti-reflective properties of the motheye films described above. Therefore, in some embodiments, less than 20%, less than 15%, less than 10%, or less than 5% of the nanostructures on a motheye film may be truncated. Reducing the number of truncated nanostructures on the motheye film of embodiments can be accomplished by using appropriate materials for molding the motheye films, designing nanostructures that are capable of withstanding forces exerted during mold release, incorporating the use of a mold release agent into processes for making the motheye films of embodiments, and using the methods described below, which reduce the likelihood of imperfect stripping of the motheye film from a template mold.

Nanostructures shaped and arranged as described above when applied to a reflective substrate, minimize or substantially eliminate reflection from the substrate. Because the motheye films of various embodiments can be created on a large scale, they can be applied to a limitless variety of glass or clear polymer substrates such as, for example, any, windows, windshields, mirrors, automotive components, building exteriors, aircraft components, military equipment, lenses, optical devices, solar cell protective or environmental covers, and the like. Such substrates typically have a refractive index in the range about 1.3 to about 1.7 over the visible light band. The motheye films in the embodiments described above and the nanostructures of the films may be composed of a material having substantially the same refractive index as the substrate, i.e., in the range about 1.3 to about 1.7 over the visible light band. Non-limiting examples materials that can be used to make the motheye films of embodiments include, but are not limited to, various silicones, various thiolenes, various polyurethanes, and other thin polymer films having an appropriate refractive index.

In certain embodiments, the motheye films may be composed of a material that is flexible, and in some embodiments, the flexible materials are also stretchable. Flexible and stretchable silicones, thiolenes, and polyurethanes are known in the art and can be used in such embodiments. For example, some embodiments are directed to motheye films disposed on curved surfaces such as windshields, visors, or lenses. Although the nanostructures are described above as extending from a flat surface, the motheye films may be curved or stretched to fit over curved surfaces without losing any antireflective properties. Thus, the motheye films described herein provide the advantage of providing antireflective properties to nearly any clear substrate having any shape.

Various embodiments are directed to methods for producing motheye films such as those described above and apparatuses for large scale production of such films. For example, the motheye films of some embodiments may be produced on rolls having widths of from about 10 cm to about 10 m, about 15 cm to about 5 m, or any individual width or range encompassed by these example ranges, and a total length of about 1 m up to about 250 m or longer.

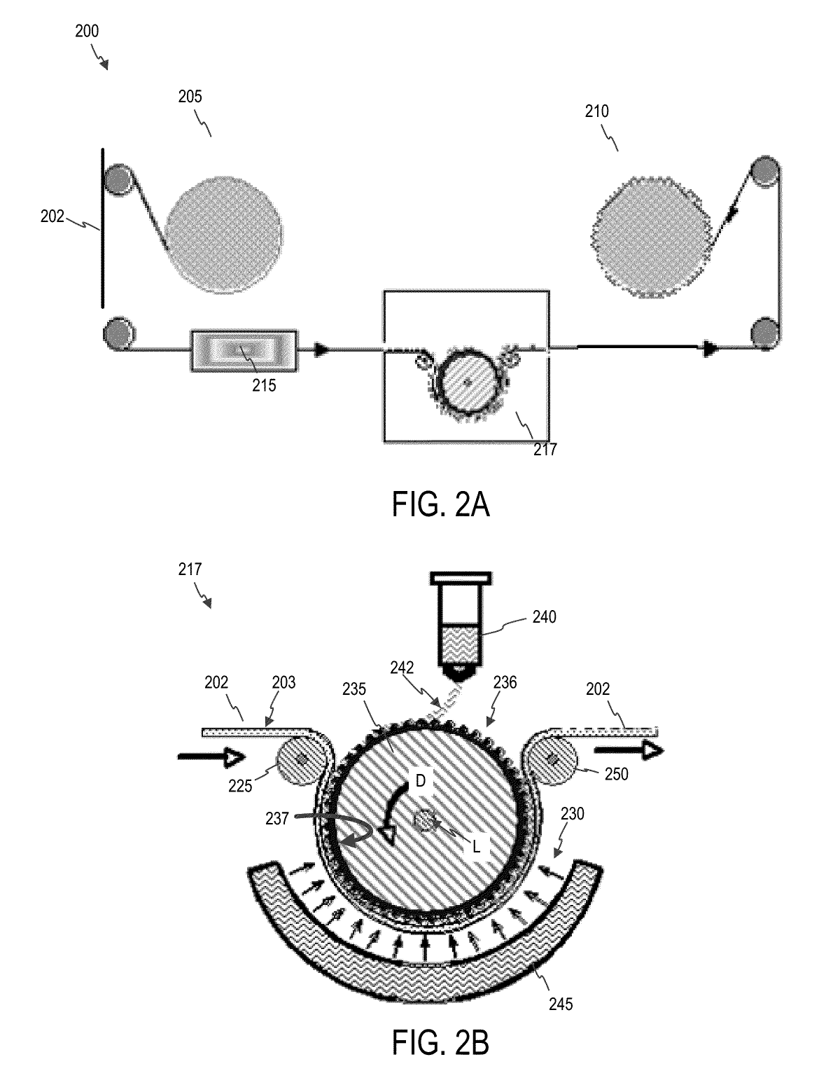

In some embodiments, the motheye film may be produced using a stamping device that can include, for example, a press tool, a drum tool, an embossing tool, a molding apparatus, and the like. An example of a stamping apparatus is shown in FIGS. 2A and 2B. The device 200 depicted in FIGS. 2A and 2B includes a drum tool 235 that imprints the nanostructures into a base film. The device 200 may include other parts useful for manufacturing large scale imprinted films such as, for example, a film unwinding apparatus 205, a film winding apparatus 210, a cleaning station 215, a patterning apparatus 217, and the like.

The film unwinding apparatus 205 may be configured to hold a roll or spool of base film 202 and meter the film out at an appropriate rate. The film unwinding apparatus 205 may further include additional rollers, conveyors, belts, and such necessary to direct the unimprinted film to the cleaning station 215. The cleaning station 215 may be configured to receive the film 202 from the film unwinding apparatus 205 and wash the unimprinted film to remove solvents or other organic contaminants from the surface of the film. The cleaning station 215 may further include additional rollers, conveyors, belts, and such necessary to direct the unimprinted film to the patterning apparatus 217, which imprints or molds nanostructures into the film 202 to produce the motheye film.

FIG. 2B is a detailed cross-sectional view of the patterning apparatus 217 shown in FIG. 2A. In some embodiments, the patterning apparatus 217 include a feeder apparatus 225 that positions the film such that a first surface 203 that is to receive a polymer layer 242 that is pressed against the drum tool 235 that molds nanostructures onto the surface of the film 202. The drum tool 235 may be configured to rotate about a longitudinal axis (L) in a direction (D) that allows the film 202 to advance from the film unwinding apparatus 205 to the film winding apparatus 210. The drum tool 235 may include a first (outside) surface 236 and a second (inside) surface 237. The first surface 236 may include a textured die that provides the inverse arrangement of nanostructures to be molded onto the film. As the drum tool 235 rotates about the axis L, a polymer 242 or adhesive may be disposed onto the first surface 236 from a polymer feed 240. The nanostructures are molded from the polymer 242 and is applied to the film 202. The combination of the film 202 and the polymer layer 242 may continue to advance as the drum tool 236 rotates, which causes the film to enter a radiation zone 230 where the polymer 242 is cured. The radiation zone 230 defines an area between the drum tool 235 and a radiation source 245 that is positioned substantially adjacent to the drum tool 235. The film 202 may stretch and advance along the first surface 236 of the drum tool without disrupting the molding process. The film 202 may remain substantially in contact with to the drum tool 235 until it is removed by the removal apparatus 250. After curing, the molded nanostructures are bonded to the film to provide the motheye film.

The drum tool 235 may be positioned at a location that is sufficiently close to the feeder apparatus 225 to affect a pressing of the polymer 242 upon the first surface 203 of the film 202. Typical pressures for molding the nanostructures from the polymer 242 and applying the molded nanostructures onto the film 202 may be from about 4×10⁶ N/m² to about 8×10⁶ N/m² or any individual pressure within these ranges, and molding may be carried out at temperatures of from about 200° C. to about 270° C. Specific pressures and temperatures may depend on the glass transition temperature (T_{G}) and mechanical properties of the polymer 242 used to mold the nanostructures. In some non-limiting examples, the polymer may include silicones, thiolenes, and polyurethanes. Alternative polymers may be used that may have additional scratch and/or deformation resistant properties. The spacing between the drum tool 235 and feeder 240 apparatus may depend on the final thickness desired for the film.

The radiation source 245 may provide radiation such as, for example, ultraviolet (UV) radiation, visible light, heating sources, microwave energy, or other types of radiation, and combinations thereof that cause curing of the polymer 242 as it passes through the radiation zone 230. The radiation provided by the radiation source 245 is not limited by this disclosure, and may provide any type of radiation that is suitable to effect curing the patterned polymer 242 applied to the film 202.

In some embodiments, the cured motheye film may contact a removal apparatus 250 as it exits the radiation zone 230. The removal apparatus 250 may be configured to remove the motheye film from the first surface 236 of the drum tool 235 in a manner that does not damage the nanostructures or pattern of nanostructures imprinted onto the film 202. In particular embodiments, the drum tool can be coated with a semi-permanent mold release agent such as, for example, Frekote 700-NC, to aid in the removal of the motheye film from the drum tool 235. In other embodiments, a temporary mold release agent such as, for example, Sprayon silicone or Krytox Dry Film PTFE mold release lubricant, may be applied to the first surface 236 of the drum tool 235 before the polymer 242 is applied to the first surface. Thus, in certain embodiments, a mold release agent feed or mold release agent sprayer (not depicted) can be positioned before the polymer feed apparatus 240.

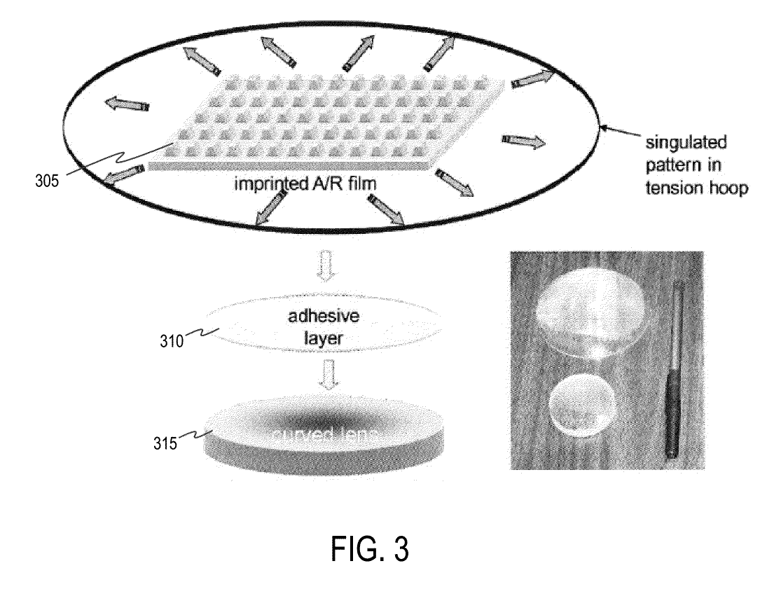

In certain embodiments, an adhesive may be necessary to properly affix the motheye film to a substrate. For example, as shown in FIG. 3, adhesion of the nanopatterned motheye film 305 to a substrate 315 may generally be accomplished through stretching of the nanopatterned motheye film 305 over the substrate 315 with an optical adhesive 310. In some embodiments, the adhesive may be applied to the motheye film during manufacture after the film has been removed from the drum tool 235 to provide an adhesive layer attached to the film 202 opposite the molded polymer 242. The film having an adhesive layer may be rolled so long as the adhesive does not bond to the molded polymer 242 in a way that disrupts or damages the nanostructures. In other embodiments, a removable sheet may be applied over the adhesive layer to cover the adhesive layer and prevent bonding to the molded polymer 242. In other embodiments, no adhesive layer may be applied directly to the motheye film during manufacture of the film, and the adhesive may be applied prior to application of the motheye film to a substrate.

Any adhesive may be used in various embodiments. For example, the adhesive may be a self-assembled monolayer, a pressure sensitive adhesive, a standard reactive adhesive, or the like. Self-assembled monolayer adhesives may use a silane coupling agent including an alkoxysilane and a reactive functional group. The silane coupling unit may covalently react with a glass substrate and the reactive functional group may react with the nanopatterned motheye film. Examples of silane coupling agents may include, for example, 3-glycidoxypropyltrimethoxysilane, (2-aminoethyl)aminopropyltriethoxysilane, aminopropyltrimethoxysilane, aminopropyltriethoxysilane, (2-aminoethyl)aminopropylmethyldimethoxysilane, methacyryloxypropylmethyltrimethoxysilane, ethacyryloxypropyltrimethoxysilane, glycidoxypropyltrimethoxysilane, mercaptopropyl trimethoxysilane, vinyltriacetoxysilane, chloropropyltrimethoxysilane, vinyltrimethoxysilane, octadecyldimethyl-[3-(trimethoxysilyl)-propyl]ammonium chloride, mercaptopropyl-methyl-dimethoxysilane, isocyanatopropyltriethoxysilane, (3-acryloxpropyl)trimethoxy-silane, and the like. For silicones or thiolene films, a slight excess of the Si—H or S—H monomer may be incorporated in the film chemistry. This may yield some of the functional groups on the film surface. An appropriate coupling agent for silicone or thiolene films may react with the substrate. Excess agent may be washed off to yield a thin monolayer. The nanopatterned motheye film may be stretched, placed in contact with the monolayer and exposed to radiation. In some embodiments, the radiation may be UV radiation. In other embodiments, the radiation may be thermal radiation. The monolayer may have dangling acrylic groups, and the dangling acrylic groups may react with any surface excess Si—H or S—H groups of the nanopatterned motheye film to create a covalent bond between the nanopatterned motheye film and the glass substrate. Amine-terminated silane coupling agents may be utilized for polyurethane nanopatterned motheye films. Examples of amine-terminated silane coupling agents may include, but are not limited to, 3-aminopropyltrimethoxysilane, 3-aminopropyltriethoxysilane, 3-aminopropyldiethoxymethylsilane, N-phenyl-3-aminopropyltrimethoxysilane, N-methylaminopropyltrimethoxysilane, N-(2-aminoethyl)-3-aminopropyltrimethoxysilane, N-(2-aminoethyl)-3-aminopropyldiethoxymethylsilane, and the like.

Pressure sensitive adhesives (PSA) may usually be polymeric materials applied between two layers for forming a bond with the desired cohesive strength upon application of a light pressure. A primary mode of bonding for a pressure sensitive adhesive may not be chemical or mechanical, but rather may be a polar attraction of an adhesive to a substrate. Pressure sensitive adhesives may be designed with a balance between flow and resistance to flow. The bond may form because the adhesive may be soft enough to flow or wet the substrate. The bond may have strength because the adhesive may be hard enough to resist flow when stress is applied to the bond. Once the adhesive and the substrate are in proximity of each other, additional molecular interactions occur, such as, for example, Van der Waals' forces, capillary forces and the like, or combinations thereof, which may provide a significant contribution to the strength of the bond. For pressure sensitive adhesives to fulfill the technical requirements described herein, at least three aspects must be considered: tack, adhesion, and cohesion. Tack is the property of a pressure sensitive adhesive that allows it to instantly adhere to a surface under very slight finger pressure. This may be determined by how quickly the adhesive can wet the substrate. Adhesion is the property of a pressure sensitive adhesive that allows it to adhere to a substrate and is typically measured by peeling the adhesive away from the substrate under specific test conditions. When peeled from a surface, the adhesive may demonstrate clean peel, cohesive splitting, delamination and the like, or combinations thereof. The rate of bond formation is determined by the conditions under which the adhesive contacts a surface and is controlled by the surface energy of the adhesive, the surface energy of the substrate, and the viscosity of the adhesive. Cohesion is the property of a pressure sensitive adhesive that allows it to resist shear stress. Cohesion may further be a measure of an adhesive's internal bond strength. Good cohesion may be necessary for a clean peel.

Pressure sensitive adhesives may normally be composed of elastic or thermoplastic base polymers, resinous tackifiers, and a plurality of additives. Examples of elastic base polymers may include, but are not limited to, synthetic rubber materials such as a silicone rubber, acrylonitrile-butadiene rubbers, silicone-modified ethylene-propylene rubbers, and urethane rubbers. Examples of thermoplastic base polymers may include, but are not limited to, polypropylenes, polyethylenes, polyesters, polyurethanes, nylons, polystyrene, poly(methyl methacrylates), polyvinylacetates, polycarbonates, poly(acrylonitrile-butadiene), styrene, polyvinylchloride, and combinations thereof. Examples of resinous tackifiers may include, but are not limited to, rosin esters, oil-soluble phenolics and polyterpenes, antioxidants, plasticizers such as mineral oil or liquid polyisobutylene, and fillers such as zinc oxide silica or hydrated alumina. Examples of additives may include, but are not limited to, plasticizers, fillers, and antioxidants. The pressure sensitivity may result from a balance of surface energy and viscoelasticity. These properties may be a function of the chemical composition, molecular weight, processing conditions, and glass transition temperature (Tg) of the materials used to make the adhesive.

In certain embodiments where a pressure sensitive adhesive is used, the pressure sensitive adhesive may include thiol-ene-based pressure sensitive adhesives and/or silicone-based pressure sensitive adhesives. An example of a thiol-ene-based pressure sensitive adhesive may include, but is not limited to, NOA61, a UV cured thiol-ene-based adhesive available from the Norland Company (Cranbury, N.J.). Examples of silicone-based pressure sensitive adhesives include, but are not limited to, DC 280, DC 282, Q2-7735, DC 7358, and Q2-7406 from Dow Corning (Midland, Mich.); PSA 750, PSA 518, PSA 910, and PSA 6574 from Momentive Performance Materials (Albany, N.Y.); KRT 001, KRT 002, and KRT 003 from ShinEtsu (Akron, Ohio); PSA 45559 from Wacker Silicones (Adrian, Mich.); and PSA 400 and PSA 401 from BlueStar Silicones (East Brunswick, N.J.). The pressure sensitive adhesive used in the present disclosure may further contain one or more thermal curing agents and/or one or more optical curing agents. Examples of thermal curing agents may include, but are not limited to, imidazoles, primary, secondary, and tertiary amines, quaternary ammonium salts, anhydrides, polysulfides, polymercaptans, phenols, carboxylic acids, polyamides, quaternary phosphonium salts, and combinations thereof. Examples of optical curing agents may include, but are not limited to, benzophenones, acetophenones, and cationic photoinitiators.

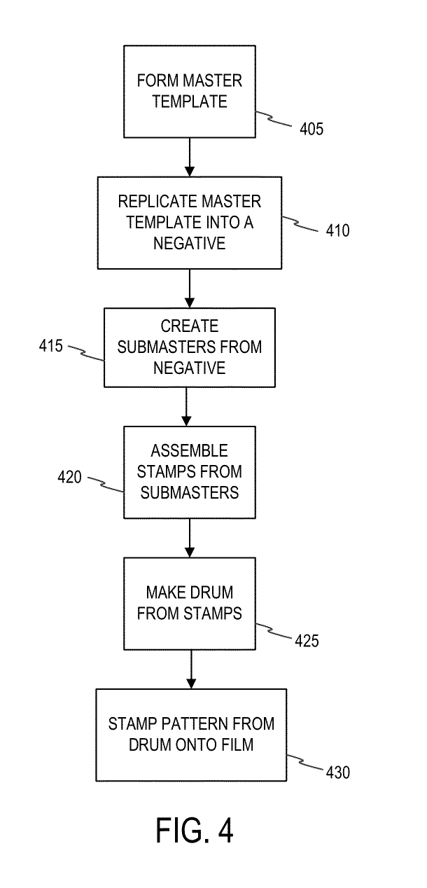

The nanostructures of various embodiments may be produced in accurate detail in a large scale operation. FIG. 4 depicts a flow diagram of a general process for fabricating an apparatus for producing a motheye films at a large scale. Such methods may include forming 405 a master template including a pattern of nanostructures, replicating 410 a negative from the master template, creating 415 submaster templates using the negative, assembling 420 stamps from the submaster templates, making 425 a drum from the stamps, and stamping 430 the nanoscale motheye pattern onto a film. Any technique for forming a master template, replicating a negative, creating submaster templates, assembling stamps, making a drum, and stamping the nanoscale motheye pattern can be used in embodiments.

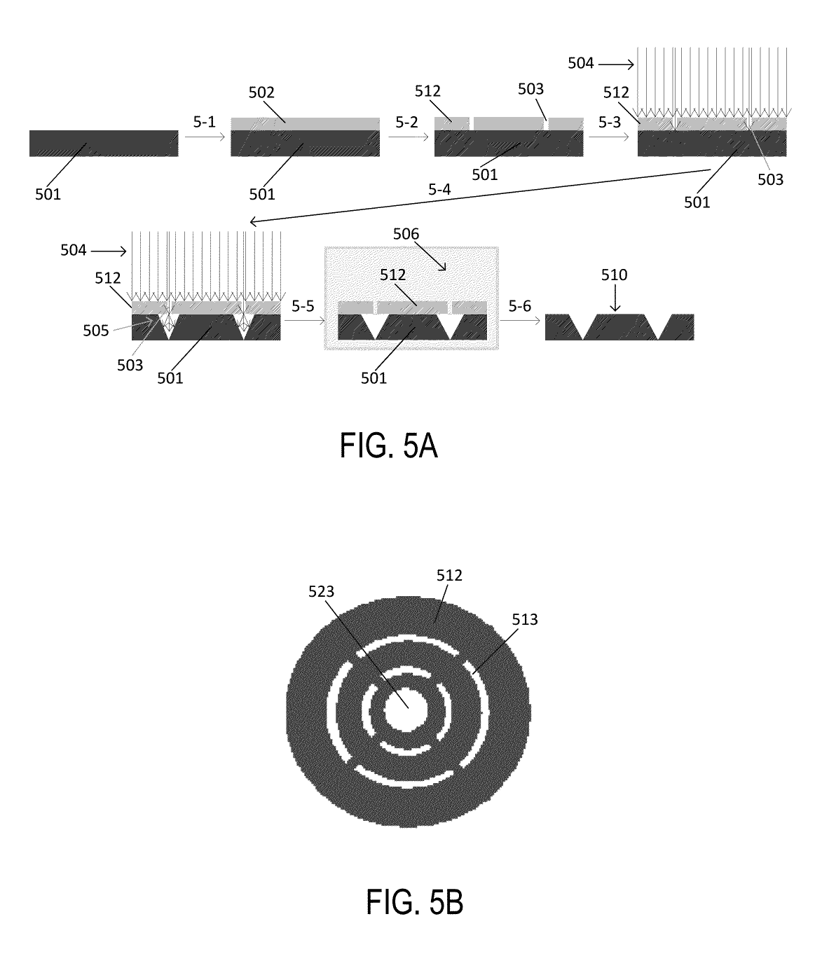

FIG. 5 is a diagram showing an example of a method for forming a master template containing a nanostructures for a motheye film. The method may include depositing 5-1 one or more layers of a resist or sacrificial material 502 on a base substrate 501. The base substrate 501 may be any type of substrate known in the art that can be removed using dry or wet etching procedures. For example, in some embodiments, the base substrate 501 may be silicon based substrate such as silicon dioxide. The sacrificial material 502 used can vary among embodiments and can be any material that can be removed or etched using a method such as e-beam lithography. Examples of e-beam resist materials include, but are not limited to, poly-hydroxystyrene (PHS), polymethyl methacrylate (PMMA), phenol based resins and phenol formaldehyde resins such as novolac polymers, thiol-ene polymers, and the like or combinations thereof.

In some embodiments, the sacrificial material may include a first layer of e-beam resist material and a second layer of a dielectric material. The first material may be any of the resist materials described above. Examples of dielectric material suitable for use in the second layer include, but are not limited to, hafnium oxide, hafnium silicate, zirconium oxide, zirconium silicate, lanthanum oxide, lanthanum silicate, tantalum oxide, tantalum silicate, titanium oxide, titanium silicate, aluminum oxide, aluminum silicate, silicon oxide, derivatives thereof, or combinations thereof.

Depositing 5-1 the sacrificial materials on the base substrate may be accomplished using any method known in the art or combinations of methods including, for example, spin coating, spray coating, dip coating, sputtering, flush coating, flow coating, conventional chemical vapor deposition (CVD), low pressure chemical vapor deposition (LPCVD), atomic layer deposition (ALD), pulsed chemical vapor deposition (P-CVD), plasma enhanced atomic layer deposition (PE-ALD), molecular beam epitaxy (MBE), and electron-beam metal deposition (EBMD).

The method may include removing portions of the sacrificial material 5-2 creating a sacrificial material having pattern of expose base substrate 512. The step of removing may be carried out in various ways. For example, in some embodiments, removing the sacrificial material can be carried out using e-beam lithography. The pattern resulting from removal of the sacrificial material will typically consist of a plurality of apertures 503 in the sacrificial material 512. The apertures 503 may have any shape. For example, the apertures 503 may be square, circular, rectangular, triangular, and the like, or the apertures 503 may be annular openings resembling straight or curved lines (FIG. 5B, 513). In some embodiments, each aperture 503 may have substantially the same shape, and in other embodiments, the apertures 503 may have various shapes. For example, the pattern may include a combination of circular apertures, square apertures, and curved line apertures. The apertures 503 of various embodiments may have substantially the same width over their entire depth. For example, circular aperture will generally have a cylindrical three dimensional shape in the sacrificial material, and a square aperture will generally have a cubical three dimensional shape in the sacrificial material. Similarly, annular openings 513 resembling straight or curved lines will generally have substantially the same width over their entire length and this width will be substantially the same through depth of the sacrificial material 512.

In the context of the apertures 503 and annular openings 513 in the sacrificial material, the term “substantially” encompasses any variation in for example width or depth caused by from removal of the sacrificial material. For example, an aperture 503 may be slightly tapered as it descends into the sacrificial material; however, such tapering will typically have no effect on further steps in the method.

In some embodiments, the method may include applying a photomask to the sacrificial material before removing portions of the sacrificial material. A photomask may include a plurality of windows that provide a pattern matching the pattern to be created in the sacrificial material. Thus, the windows may have any of the shapes described above including for example, square, circular, rectangular, triangular, and the like, or straight or curved lines. After applying the photomask, the sacrificial material exposed through the windows is removed leaving a pattern of apertures in the sacrificial material. The photomask may be removed after removing the sacrificial material, or the photomask may remain in place throughout the remainder of the method.

Removing sacrificial material results in a pattern of apertures 503 in the sacrificial material 512 to produce a mask. In some embodiments, the pattern in the mask may be a periodic pattern of apertures 503 in which each aperture has a similar shape and size. In other embodiments, the pattern may include apertures of different sizes and shape. In still other embodiments, the pattern may include a series of annular openings 513 or a combination of apertures 523 and annular openings 513, as illustrated in FIG. 5B.

When patterning is completed, the base material exposed through the mask may be etched. Etching 5-3 can be carried out by any method including, for example, dry etching, wet etching, ion-assisted dry etching, ion-assisted wet etching, or combinations thereof. The etching method and chemistry can be varied among embodiments depending upon the material used as the base material. During dry etching, a collimated ion source 504 is used to bombard the base material through the aperture 503 or annular opening etching the base material 501. As base material 501 is removed as a result of etching the ions entering the aperture 503 or annular opening can diffract 505 creating a tapered bore into the base material 501, and for circular apertures, etching eventually produces a conical shaped bore in the base material. In some embodiments, these conical shaped bores may be a negative imprint of a nanostructure, and a pattern of these conical shaped bores can be used to as a mold to produce the motheye films described above.

Wet etching 5-5 processes use liquid-phase etchants 506, for example, buffered hydrofluoric acid or ferric chloride to etch the base substrate. This is typically carried out by immersing the base substrate 501 and the mask of sacrificial material 512 in an etchant bath, which can be agitated to achieve good process control. During emersion, the wet etchant 506 contacts the base substrate 501 through the aperture 503 or annular openings and etches the base substrate 501. Like dry etching, as the base material 501 is removed tapered bores in the base material 501 are created producing, for example, conical shaped bores in the base material 501 for circular apertures. In some embodiments, these conical shaped bores may be a negative imprint of a nanostructure, and a pattern of these conical shaped bores can be used as a mold to produce the motheye films described above.

As illustrated in FIG. 5A in particular embodiments, dry etching may be carried out in a first etching 5-4 step followed by a wet etching step 5-5. In such embodiments, wet etching 5-5 may increase the sharpness of the tips of the nanostructures producing a better overall mold.

Once etching is completed, the method may include removing the sacrificial material 5-6 to produce the completed mold 510. Removing the sacrificial material 5-6 may be carried out through the use of any technique now known or later developed for removing unexposed sacrificial material, such as, for example, lift off techniques, wash techniques, use of etchants, and the like. Radiation sources may be utilized to develop the pattern.

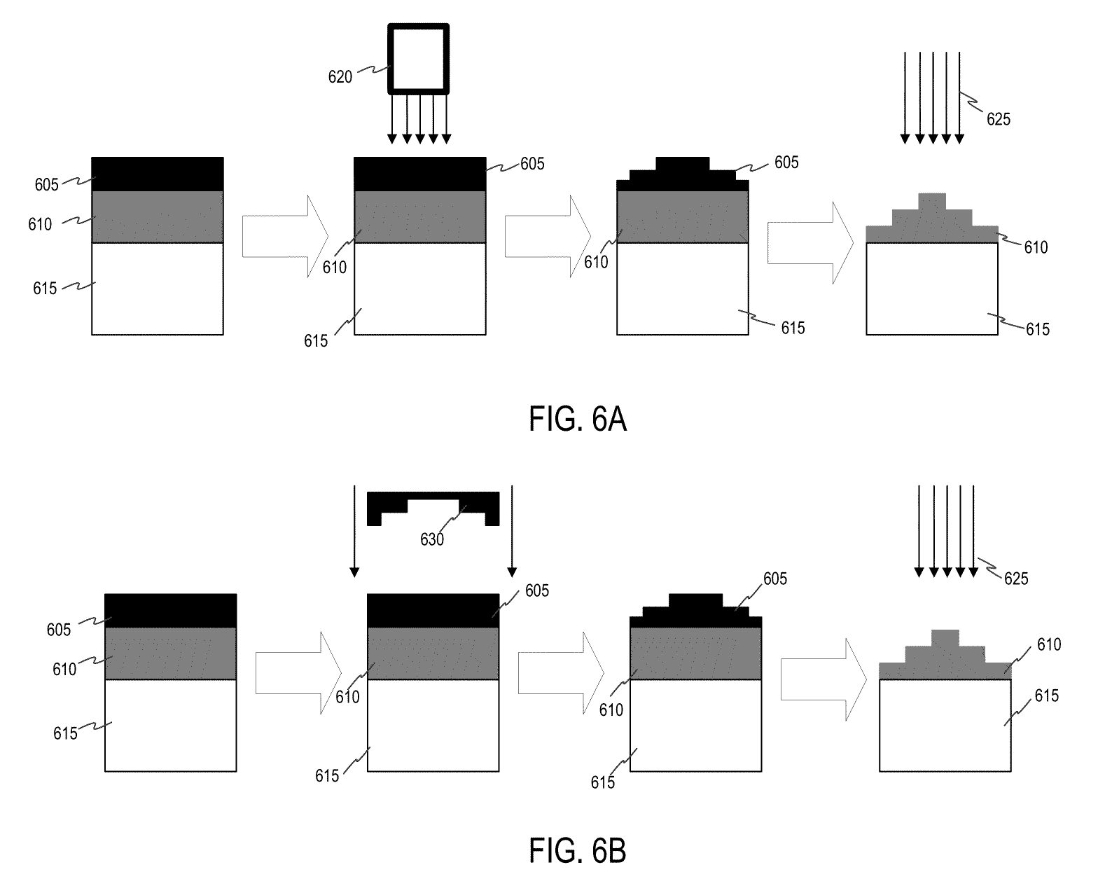

FIGS. 6A and 6B are schematic diagrams of a method of forming a nanoscale motheye pattern according to various embodiments, such as the method described in FIG. 5 herein. In some embodiments, this method may be used for creating a master template. In other embodiments, this method may be used for creating a large scale application, as described in greater detail herein. In particular embodiments, a first layer 605 of material and a second layer 610 of material may be deposited upon a base layer 615. In some embodiments, the first layer 605 may be an e-beam resist material, as described in greater detail herein. In some embodiments, the second layer 610 may also be an e-beam resist material. In other embodiments, the second layer 610 of material may be a dielectric composition. The second layer 610, when it is a dielectric composition, may have a refractive index that is similar to glass. Examples of suitable dielectric compositions may include, for example, poly-(para-xylylenes), silsesquioxanes poly-benzocyclobutenes, poly(methyl methacrylate) (PMMA), anodic acrylics, cathodic acrylics, epoxies, polyesters, polyurethanes, polyimides, and oleoresinous compositions, or combinations thereof. While only two layers are depicted herein, those skilled in the art will recognize that fewer or greater layers may be used without departing from the scope of the present disclosure.

The layers 605, 610 may be exposed to an electron beam 620, as previously described. Exposure to the electron beam 620 may be completed at varying doses to create varying shapes and sizes, as described in greater detail herein. In alternative embodiments, the layers 605, 610 may be nanoimprinted with a nanoimprinting apparatus 630, as shown in FIG. 6B. The nanoimprinting apparatus 630 may generally create patterns by mechanical deformation of the first layer 605 and the second layer 610.

After exposure to the electron beam and/or nanoimprinting, the layers 605, 610 may be wet etched. As a final step, the layers 605, 610 may undergo reactive-ion etching (RIE) 625. RIE is a variation of plasma etching in which, during etching, the layers are placed on an RF powered electrode. Plasma may be generated under low pressure in a vacuum by an electromagnetic field. The plasma may generally be a chemically reactive plasma to remove at least a portion of the material present in the first layer 605 and/or the second layer 610. High-energy ions from the plasma may attack the surface of the layers 605, 610 and react with them. The layers 605, 610 may take on potential that accelerates etching species extracted from plasma toward the etched surface. A chemical etching reaction may take place in the direction normal to the surface.

In some embodiments, the e-beam resist material in the first layer 605 and/or the second layer 610 may be a polymer that includes at least a thiol-ene. The thiol-ene may be created by combining a dithiol with a diene. Thiolene polymerization is a free-radical addition reaction where the hydrogen is extracted from the H—S bond by an initiator, leaving a sulfur radical.

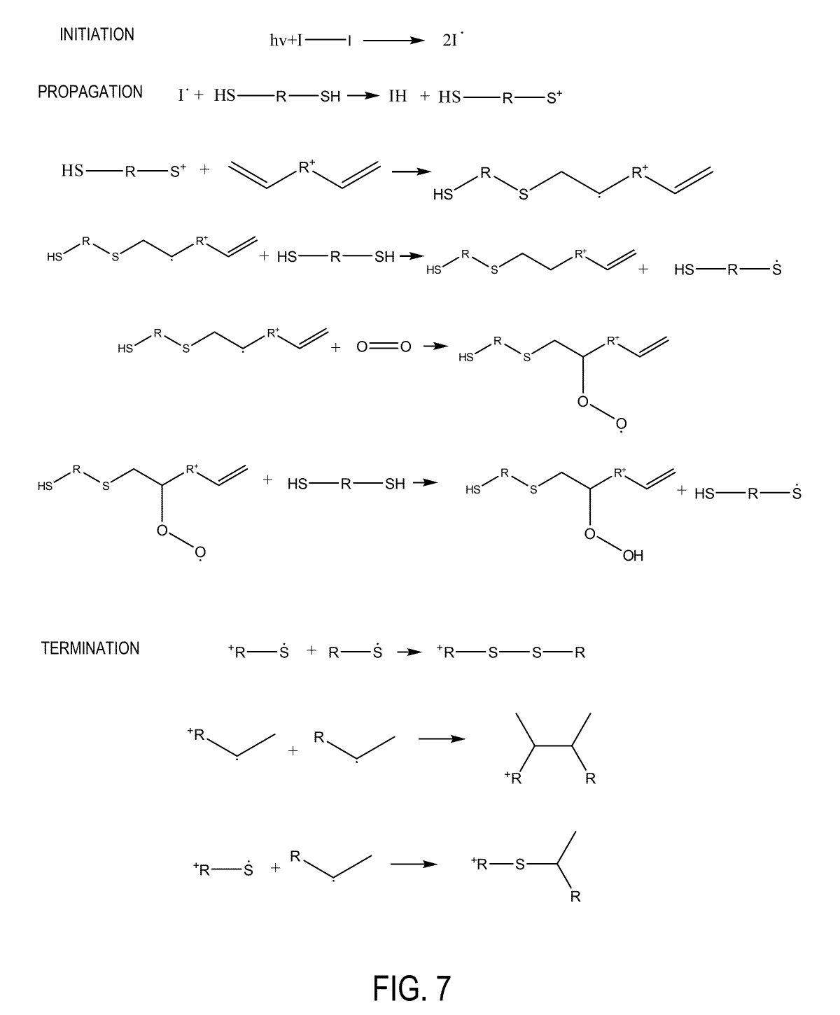

FIG. 7 depicts the initiation, propagation and termination steps of a thiolene free-radical addition reaction according to various embodiments. The radical then adds across the unsaturated carbon-carbon bond. The new radical is then able to extract hydrogen from another H—S group. This can propagate until there are no functional groups left. One advantage of thiolene chemistry versus acrylates is that thiolene reactions do not exhibit oxygen inhibition. This means that polymer formation can take in a regular ambient environment. The thiolene reaction is known as a “click” reaction. This type of reaction yields a very regular alternating thiol and ene structure, as the two functional groups precisely react with each other and “click” together.

Free-radical addition polymerization starts with an initiation step, where an initiator is decomposed to form radical byproducts. The initiation step can be completed via either thermal decomposition or photo decomposition. For thiolenes, photoinitiation has the advantages of speed and completeness of reaction. Photoinitiation may require the use of one or more photopolymerization initiators. Examples of photopolymerization initiators may include, but are not limited to, benzoin, benzoin methyl ether, benzoin ethyl ether, benzoin isopropyl ether, benzoin-n-butyl ether, benzoin isobutyl ether, acetophenone, dimethylacetophenone, 2,2-dimethoxy-2-phenylacetophenone (DMPA), 2,2-diethoxy-2-phenylacetophenone, 2-hydroxy-2-methyl-1-phenylpropane-1-one, 1-hydroxycyclohexyl phenyl ketone, 2-methyl-1-[4-(methylthio)phenyl]-2-morpholino propane-1-one, 4-(2-hydroxyethoxy)phenyl-2-hydroxy-2-propylketone, benzophenone, p-phenylbenzophenone, 4,4-diethylamino benzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-isopropylthioxanthone, 2-chlorothioxanthone, 2,4-dimethylthioxanthone, 2,4-diethylthioxanthone, benzyl dimethyl ketal, acetophenone dimethyl ketal, 2,4,6-trimethyl benzoyldiphenyl phosphine oxide, 6-trimethyl benzoyl diphenylphosphine oxide, 2-benzyl-2-dimethylamino-1-(4-morpholinophenyl)-butan-1-one, bis(2,6-dimethoxybenzoyl)-2,4,4-trimethylpentylphosphine oxide p-dimethyl aminobenzoate, and combinations thereof. When exposed to UV radiation, the photopolymerization initiator cleaves into two free-radicals which begin the polymerization reaction.

Thiol-ene chemistry is analogous to that of silane polymerization. In both thiol-ene chemistry and silane polymerization, an alkene (an unsaturated carbon-carbon double bond) may be reacted in an addition reaction with a hydride terminated polymer or monomer (either S—H for thiol-enes or Si—H for silanes). Examples of alkenes include, but are not limited to, ethene, propene, butene, pentene, hexene, heptene, octene, decene, pentenenitrils, cyclohexene, and styrene. For maximum molecular weight polymers, equal ratios of the hydride and alkene functional groups are utilized. For linear chain growth, the reactive unit (monomer or oligomer) must have two functional groups. If it only has one, then it is utilized as a capping point. Capping points terminate the addition reaction and control the molecular weight of the polymer.

When a crosslinked system is desired, monomers with three or more functional groups may be added. Examples of monomers may include pentaerythritol tetraacrylate, tris(2-hydroxyethyl)isocyanurate triacrylate, trimethylol propyl triacrylate, dipentaerythritol hexaacrylate, dipentaerythritol pentaacrylate, 2,2,4,4,6,6-hexahydro-2,2,4,4,6,6-hexakis(2-((2-methyl-1-oxo-2-propenyl)oxy)ethoxy)-1,3,5,2,4,6-triazatriphosphorine, U6HA (hexafunctional urethane(meth)acrylate), U4HA (tetrafunctional urethane(meth)acrylate), tricyclodecane dimethanol diacrylate, tris(2-hydroxyethyl)isocyanurate diacrylate, pentaerythritol tetraacrylate, tris(2-hydroxyethyl)isocyanurate triacrylate, dipentaerythritol hexaacrylate, and U6HA, or combinations thereof. These allow both chain growth, as well as connecting/bridging adjacent chains. The physical properties (modulus, elasticity, Tg, etc.) of a polymer can be controlled through the amount of crosslinking groups added. The type of structure (e.g., aromatic rings versus long aliphatic chains) between functional groups will also affect the physical properties of the resulting polymer.

For thiolenes, the percent of tetrathiol may be altered to increase crosslinking, which will in turn alter Young's modulus, the shear modulus, and the Tg. The amount of UV initiator may also be varied. Then the number of excess S—H groups that are needed for surface monolayer to bond the film to the glass may be determined. If necessary, thermal curing may also be used. The crosslinking units may be kept to less than 10% by weight of the total polymer and the initiator to less than 1%. In some embodiments, the initiator may be kept to less than 0.1%.

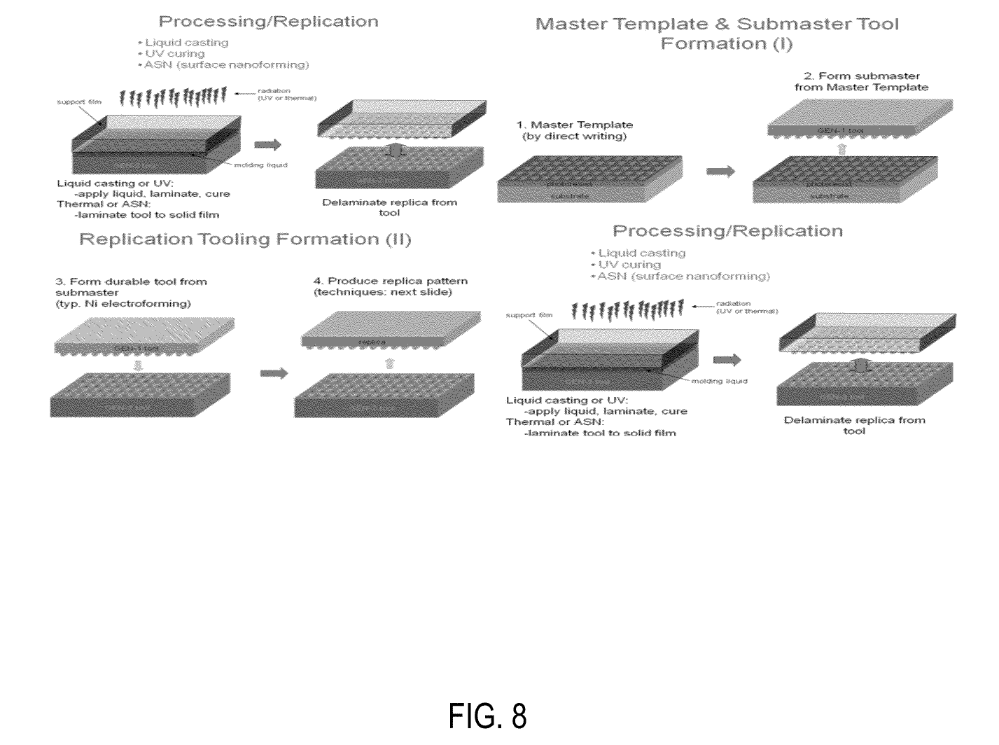

FIG. 8 is a schematic diagram for replicating the master template into a negative, creating submasters from the negative, and assembly of the stamps from the submasters according to various embodiments. The replication techniques used to create a negative and submasters from the negative are not limited by this disclosure, and may include any replication techniques now known or later developed. Examples of replication techniques may include, for example, liquid casting with a thermal or UV cure, hot embossing, and Advanced Surface Nanoforming™ (ASM) (MicroContinuum, Inc., Cambridge, Mass.). In some embodiments, liquid casting replication may include applying a liquid to the surface of the master template, laminating the master template, and curing the laminate. The cured replica may then be delaminated from the master template and used to form submasters.

In some embodiments, replicating the nanoscale motheye pattern in a polymeric layer may include producing imprint tooling. Tooling fabrication may include production of a set of copies (both positive and negative) of the master template and production of a set of electroformed tools from the copies, as previously described herein.

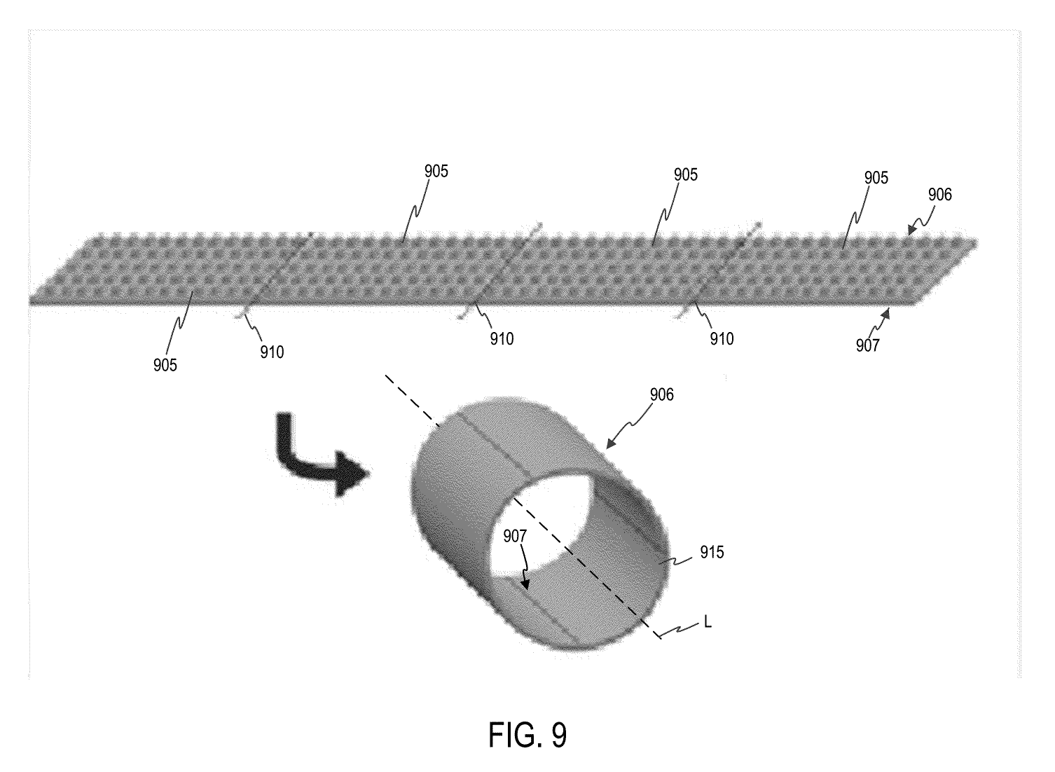

FIG. 9 depicts a schematic diagram for fabricating a cylindrical drum tool 915 for use in a large scale application according to various embodiments, such as those previously described herein. The drum tool 915 may include a ganged array of individual tool elements 905. Each individual tool element 905 may be a single nickel piece called a shim, as previously described herein. Each shim 905 may have a first surface 906 and a second surface 907. The first surface 906 may generally include the textured nanoscale motheye pattern as formed according to embodiments discussed herein. Each shim 905 may be precisely cut and formed so that it can joined with other shims 905 via laser microwelds 910 to form the drum tool 915. The drum tool 915 may formed by bringing the two end shims 905 together with a laser microweld 910 in such a manner that the first surface 906 is on the outside of the drum tool 915 and the second surface 907 is on the inside of the drum tool 915. The resulting configuration may allow the drum tool to rotate about a longitudinal axis L to press the nanoscale motheye pattern into a film as described in greater detail herein.

The number of shims 905 used to form the drum tool 915 may vary. Variations may be due to the size of each shim 905, the size of the film upon which the master pattern is created, and the desired size of the end product. The size may generally be independent of the nanoscale motheye pattern size. In certain embodiments, a 6-inch wide drum may be formed from 8 shims, where each shim is fabricated from a 6-inch square silicon wafer. In other embodiments, a 6-inch wide drum may be formed from 30 shims, where each shim is fabricated from a 3-inch square silicon wafer.

Some embodiments are directed to methods for applying a motheye film to a substrate, and in particular embodiments, the motheye film may be permanently attached to the substrate. In certain embodiments, fully cured motheye films made as described above may retain sufficient adhesive properties to bond directly to a substrate. Thus, methods for applying a motheye film may require the steps of applying a fully cured motheye film directly to a substrate. In some embodiments, such methods may include the steps of stretching the film over the substrate, contacting the substrate with a motheye film, and applying pressure to the motheye film to effect adhesion or combinations thereof. In other embodiments, an adhesive layer may be disposed between the motheye film and the substrate. In some embodiments, an adhesive layer may be applied to the cured motheye film during manufacture or before contacting a substrate with the motheye film. In other embodiments, such methods may include the step of applying an adhesive layer to the substrate and bonding the motheye film to the substrate through the adhesive layer. In embodiments in which an adhesive layer is used, the adhesive should adhere strongly to both the motheye film and the substrate and the adhesive layer should exhibit good optical clarity by having a refractive index that is substantially the same as the refractive index of the substrate and the film.

In other embodiments, a 2-ply laminate film containing a polymer layer and a template layer may be bonded to a substrate and the template layer may be removed. The template layer of such embodiments may include a negative motheye pattern and, in some embodiments, may be flexible and stretchable to allow the 2-ply laminate to assume a variety of shapes. Methods for applying motheye films using a 2-ply laminate may include the steps of coating the template layer having the negative motheye pattern with a polymer to create the 2-ply laminate and, in some embodiments, curing polymer. The methods may further include the step of applying an adhesive to substrate and contacting the adhesive with the polymer portion of the 2-ply laminate or applying an adhesive to the polymer portion of the 2-ply laminate and contacting the substrate with the adhesive. In either embodiments, the adhesive may be cured using, for example, heat or radiation such a UV radiation, to permanently bond the motheye film to the substrate through the adhesive. After bonding to the substrate, the template layer can be removed leaving the motheye film bonded to the substrate. The template layer can then be discarded or reused to create another motheye film coated substrate.

In other embodiments, such methods may include the steps of coating the template layer having the negative motheye pattern with a polymer to create the 2-ply laminate. However, the polymer may remain uncured or may be partially cured. The methods may further include the step of contacting the substrate with the 2-ply laminate and curing the polymer after contacting the substrate such that a permanent bond is created between the substrate and the polymer. Curing may be carried out by any methods including, for example, heat or radiation such a UV radiation, to permanently bond the motheye film to the substrate or in other embodiments, an adhesive may be disposed between the polymer layer of the 2-ply laminate and the substrate. As suggested above, the polymer in such embodiments can be fully cured, uncured, or partially cured before bonding to the substrate and upon bonding will be fully cured. After bonding to the substrate, the template layer can be removed leaving the motheye film bonded to the substrate. The template layer can then be discarded or reused to create another motheye film coated substrate. Because the polymer is cured on the substrate in such embodiments, a cured polymer that is inflexible and rigid such as acrylic may be used to create the motheye film since after it has been affixed to the substrate no further stretching or flexibility is necessary. Thus, for example, the motheye films of some embodiments may be composed of the same material as the substrate without etching. In other embodiments the polymer used in embodiments in which the polymer is cured on the substrate may be a flexible and stretchable polymer such as those described above.

In any of the embodiments described above that include a template layer, the methods may further include the step of adding a mold release agent to the template layer to allow the cured polymer to be easily released from the template layer. Thus, methods may include the steps of applying a mold release agent to a template and coating the template with a polymer to create a 2-ply laminate.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

### EXAMPLES

Although the present invention has been described in considerable detail with reference to certain preferred embodiments thereof, other versions are possible. Therefore, the spirit and scope of the appended claims should not be limited to the description and the preferred versions contained within this specification. Various aspects of the present invention will be illustrated with reference to the following non-limiting examples. The following examples are for illustrative purposes only and are not to be construed as limiting the invention in any manner.

### Example 1

### Polymer Film Selection

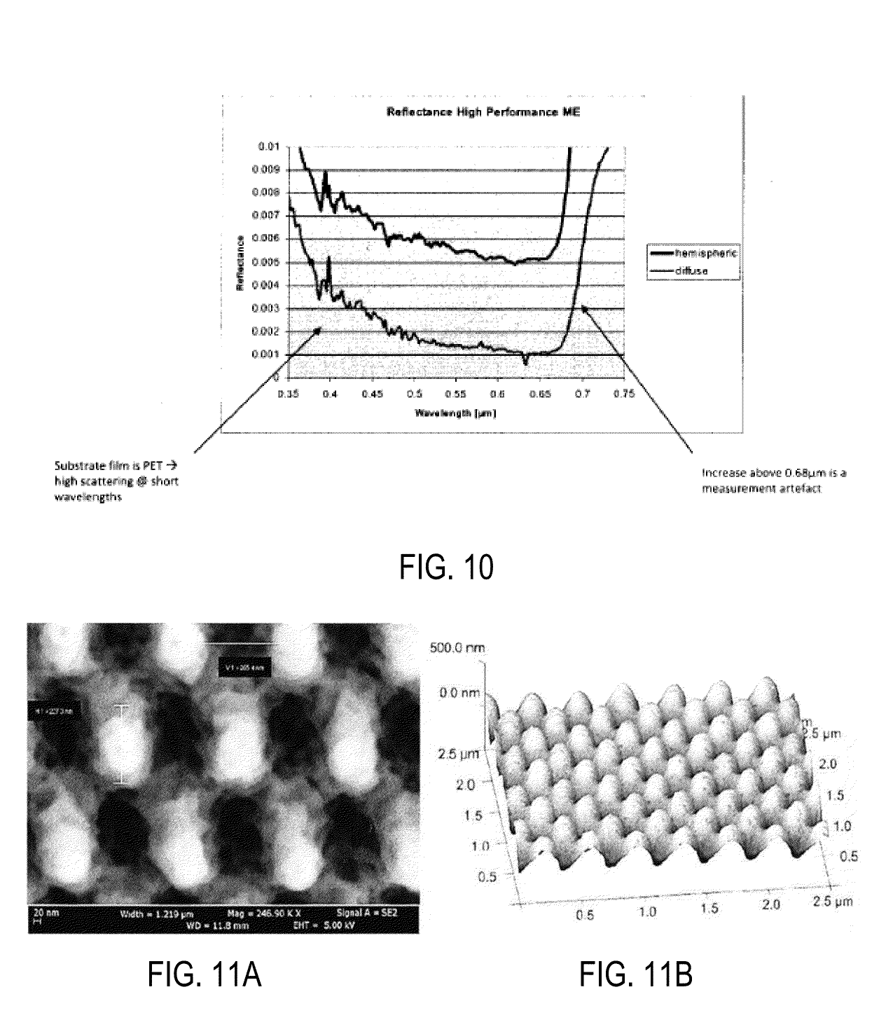

A high precision nickel (Ni) master template was used to complete casting. The initial casting tests on the master were performed in a glove box, fitted with Class 100 filtering to achieve a good clean room environment in order to avoid particulate contamination and damage of the Ni master. Previous PET impressions of an identical Ni master were made and the reflectance spectrum measured is shown in FIG. 10. From this data, reflectance of less than 1% over the band 0.35-0.7 μm is expected. Scanning Electron Microscopy (SEM) measurements of the Ni master are shown in FIG. 11A and Atomic Force Microscopy (AFM) measurements of the Ni master are shown in FIG. 11B. Both indicate that the feature heights and spacings are on the order of 350-400 nm.

The silicone used in the initial casting was a Sylgard® (Dow Corning Corporation, Midland Mich.) polydimethylsiloxane (PDMS) material. The PDMS consists of a base resin and hardener, which were mixed in a 10:1 ratio. The mixture was then degassed in a vacuum oven for 2 hours to remove any air introduced during the mixing process. The silicone was then applied to the Ni master on a 75° C. hot plate, which is required to cure the PDMS. After 1 hour of curing, the hot plate was shut off and allowed to cool. The PDMS sample separated easily from the Ni master surface. There was no visible change in the surface of the Ni master after casting, even when viewed at high angles of incidence; this indicated no apparent damage to the Ni master surface due to the silicone casting.

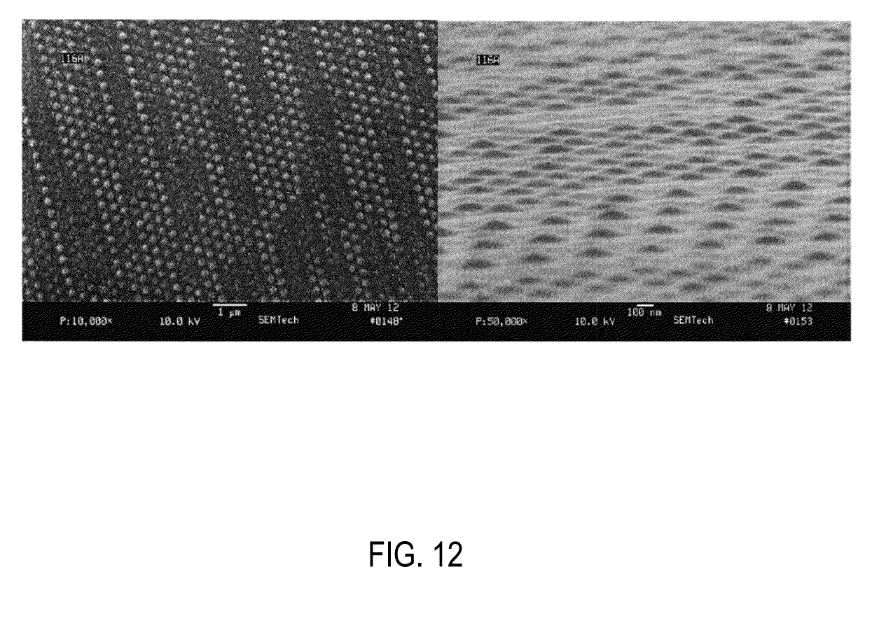

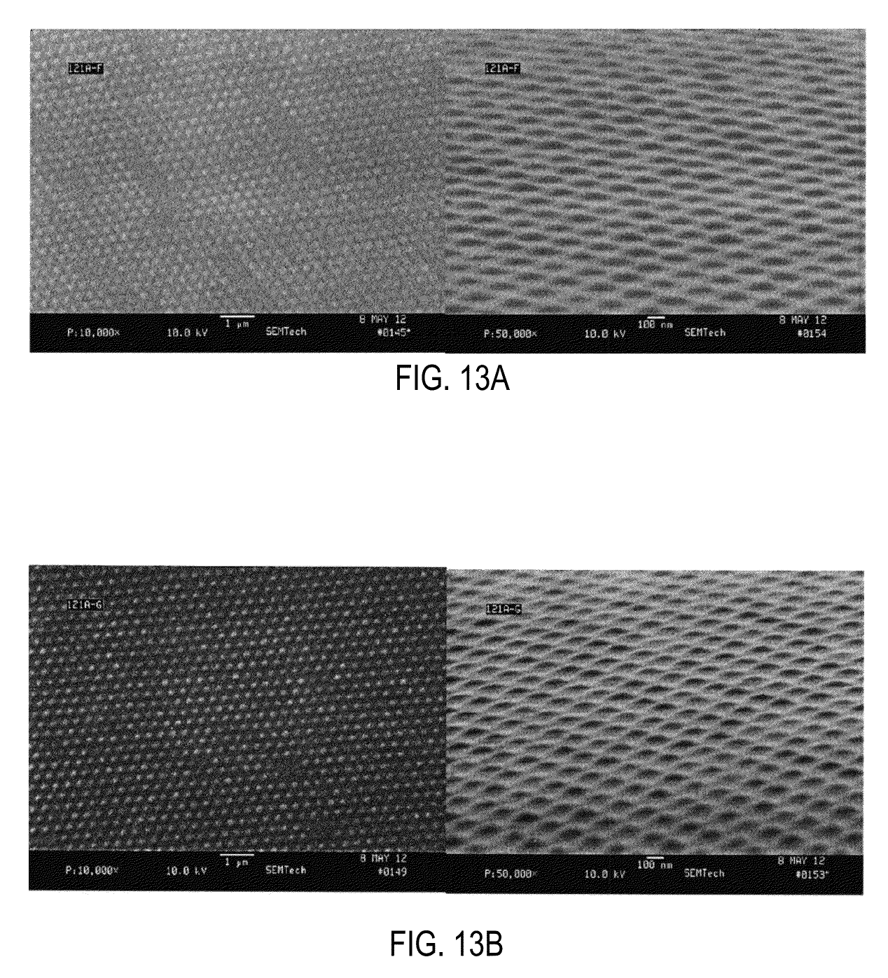

Initial reflectance spectra from this cast material was collected using a Filmetrics® F20 Unit (San Diego, Calif.) at a normal angle of incidence. The reflectance of the textured Sylgard® was 1.8%, whereas the untextured Sylgard® area showed a reflectance of 4.8%. Therefore, while the motheye texture from this initial test appeared to reduce the overall reflectance, it was still not as low as the expected range shown. A possible reason for this higher reflectance may be reflectance from the unpatterned back of the Sylgard® material. SEM images of this casting are shown in FIG. 12, and indicate significant areas where there is no patterning and have a bump height of only 50-100 nm.

A second casting was made. The second casting used thicker, rigid polymers as the rear side of the Sylgard® cast material in an effort to minimize any contributions to the total reflection from the back substrate. Both a thicker soda-lime substrate and an FR4 composite substrate were used. The FR4 substrate material had a small amount of the patterned Sylgard® hanging off of the edge. This unsupported textured Sylgard® material had a measured reflectance of 0.2%, which is similar to the expected reflectance. This appears to confirm that the rear surface interface is contributing to the overall measured reflectance. The FR4 and soda lime backed castings were also measured via SEM. These images, as depicted in FIGS. 13A and 13B, showed better fidelity, with fewer areas of absent patterning. The film with the soda lime substrate appeared to show the best pattern transfer fidelity, although the apparent height by SEM was still less than expected at approximately 100 nm.

PDMS materials, such as Sylgard® may suffer from a lack of durability. Thus, as an alternative to PDMS materials, other optical-grade silicone formulations with differing Shore A hardness values may be used. For example, an optical-grade silicone formulation with a Shore A hardness of 74 and an optical-grade silicone formulation with a Shore A hardness of 52 may be used instead of the PDMS materials.

### Example 2

### UV Curing Technique

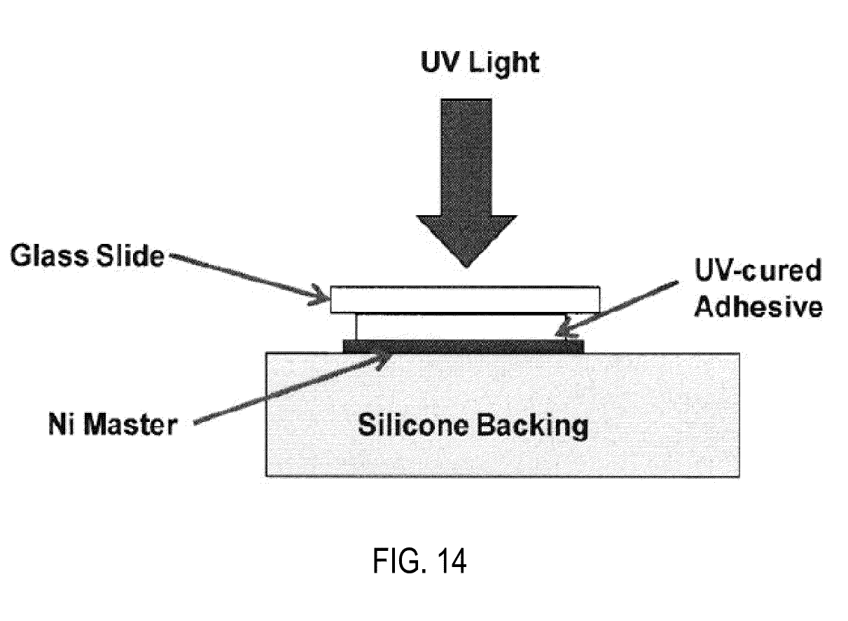

In addition to different silicone materials as described herein, different nanopattern capture techniques were also explored. One technique, as shown in FIG. 14, uses a UV-curable polymer, which is cured while in contact with the master. The material used was optical adhesive UV91A (Norland Products Inc., Cranbury, N.J.), which is the same methacrylate-based adhesive used in bonding tests.

Testing involved pressing the Ni master onto a glass slide coated with the optical adhesive. This combination was then UV cured while in contact and then separated afterwards. SEM measurements of the resulting nanopattern showed very good fidelity to the Ni master, with feature depths of 320 nm.

### Example 4

### Hot Embossing Technique

Another nanopatterning technique that has been previously used is hot embossing. This technique involves taking a polymer film on a rigid substrate and pressing the polymer into contact with the nanopattern master. The master is heated above glass transition temperature (T_{g}) of the polymer. After pressing, the heat is turned off and the master is allowed to cool below the glass transition temperature before it is removed from the polymer.

Attempts to use this method involved the use of a clear polyurethane material cast onto a flag rigid substrate from a solution in dimethylacetamide (DMAC). The polymer was brought into contact with the Ni master, which was heated to 200° C., with a force of about 3,000 pounds. After 20 minutes, the heated press was shut off and allowed to cool. SEM measurements of the patterned polyurethane on glass showed good fidelity to the Ni master, however, the hot-embossed polyurethane also showed significant distortion when removed from the rigid substrate.

### Example 5

### Abrasion Resistance

A significant area of concern is how the motheye structures cope with expected handling during operational lifetime. A sample of the cast silicone motheye on borosilicate glass was used for a number of abrasion resistance tests. The tests, as shown in Table 1 below, were performed in chronological order from top to bottom. After each test, the reflectance was measured.

TABLE 1
Abrasion Test

| Test | Average Reflectance After Test |
|---|---|
| As Is (Control) | 0.9% |
| Pressed Surface with Gloved Fingertip | 0.73% |
| Tape Pull Test | 0.82% |
| Pressed Surface with Bare Fingertip | 0.76% |
| Wiped with Ethyl Alcohol and Kimwipe | 0.59% |
| Scrubbed Hard with Kimwipe | 1.55% |
| Removed Kimwipe Debris with Tape | 1.05% |

These durability tests indicate that for moderate handling, the motheye structures are resistant to damage. However, it is anticipated that in field use, the AR coatings will encounter more severe abrasion.

### Example 6

### Measuring Reflectance

Reflectance standards were obtained for using motheye films on BK7 flat glass. Measurements were taken using an instrument having a monochrometer source and optical parts to measure both transmission and reflectance at various angles of incidence up to 60°. The detector is operated through a beam chopper and lock-in amplifier in order to measure very small absolute reflectance and accompanying small optical signals, which would be difficult to detect. The measured standards were compared to published P and S reflectance vs. angle measurements for uncoated BK7 glass flat.

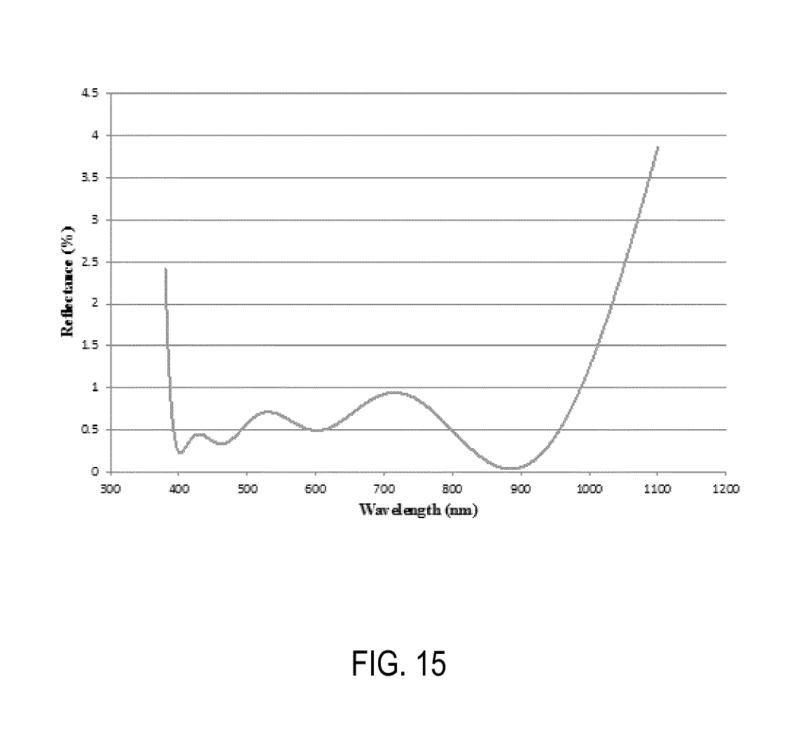

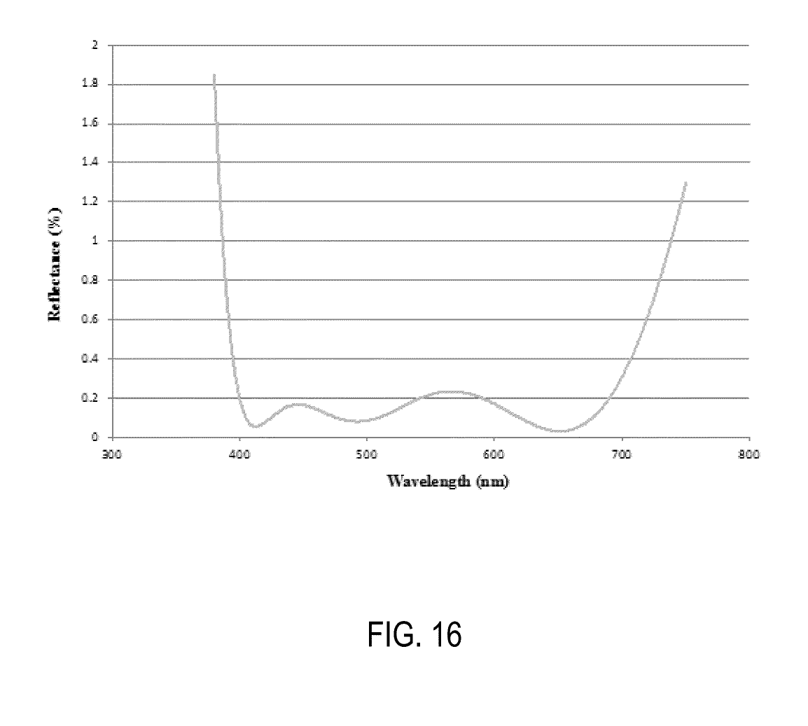

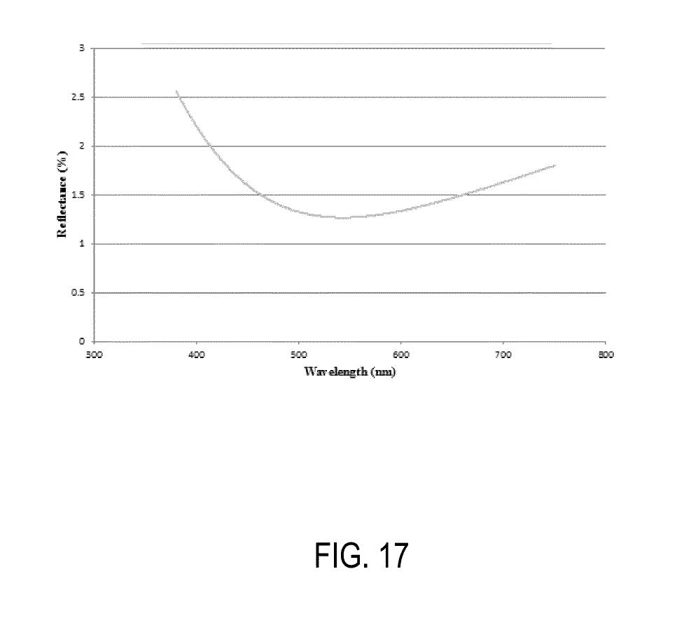

FIG. 15 shows the VIS-NIR reflectance measured from BK7 flat coated with multilayer thin film. FIG. 16 shows the VIS-NIR reflectance measured from BK7 flat coating optimized for VIS only, and FIG. 17 shows the VIS-NIR reflectance measured from a Borofloat window with a single layer MgF₂ “V Coat,” a common anti-reflective coating.

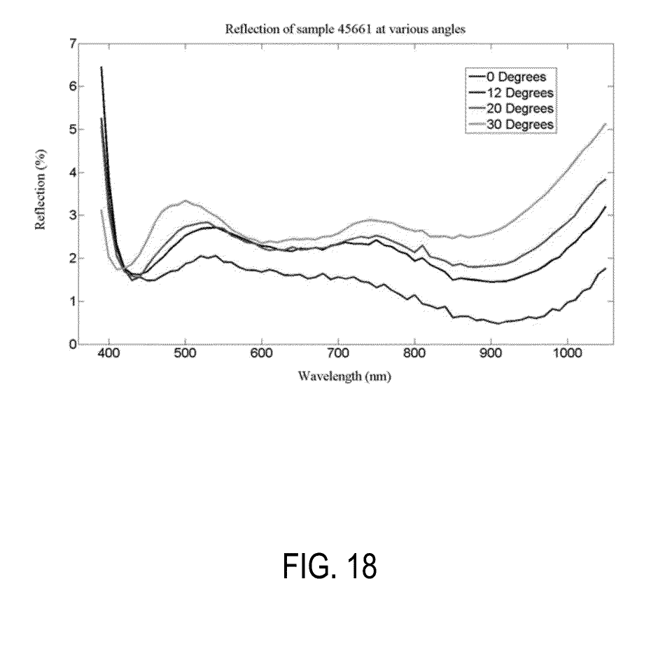

A set of measurements applied to the sample with a broadband VIS-NIR coating corresponding to FIG. 15 is shown in FIG. 18. Because the monochrometer beam collimation was imperfect, normal reflectance could not be measured directly, but only reflectance at angles of 12° or greater. The 0° curve shown in the graph was actually backed out from a transmission measurement, hence a higher noise level. Also due to collimation limitations, it was difficult to separate the front and back surface reflections, which accounts for the incorrectly large reflectance seen in FIG. 18.

### Example 7

### Creating a Master

A combination dry-etching, wet etching and e-beam lithography will be used to fabricate the required moth-eye nanostructures with an aspect ratio of 3:1 and strict dimensional requirements. The shape of the final structure can be adjusted by trial and error to approximate a desired mathematical 3D form, within fabrication limits.

Two approaches will be evaluated. In the first approach, the process consists of five steps:
1. Using a substrate such as a silicon wafer, a masking material made of Cr or an e-beam resist will be deposited.
2. Using an e-beam writer, a periodic pattern of apertures will be created in the masking or resist material. These openings can be of various shapes such as circular, triangular or square in shape, which will influence the final 3D protrusion shape.
3. Next the mask is subjected to an ion assisted dry-etching process using an etching chemistry best suited to the substrate. Due to diffraction of the accelerated etching ions, an etching slope of the final 3D structure will result. This slope will depend on the size and shape of the initial opening as well as the energy of the accelerated ions.
4. A controlled wet etching step can be used to enhance and further control the slope of the etched structures.
5. The etching mask is removed and a final template is obtained.

In a second approach, instead of open apertures, a periodic pattern of annular openings will be created in the mask or resist using the e-beam writer. These annular openings can be of various shapes such as circular, triangular or square and the dimensions can have a varying width. Some connecting bars will remain unopened to provide support for the resulting mask during the etching process. As the dry-etching speed depends on the opening thickness, a gradation of the etched depth is expected to result providing the desired 3D Motheye nanostructure shape. The slope of the final features will depend on the number of annular portions constituting each nanostructure as well as their relative widths. As in Approach 1, a controlled wet etching step can be used to enhance and also control the slope of the etched structures.

In the first phase of fabrication tests, small 50 μm×50 μm coupons will be generated to study control of the process. These will be measured by SEM, AFM and microscopic FTIR to determine which methods provide the most accurate master. In a second phase, 2 mm×2 mm samples will be fabricated for reflectance measurements.

### Example 8

### Motheye Films Made Using a Template Layer

A flexible silicone mold was made by mixing Sylgard® 184 Silicone Elastomer with A:B=1:6 by weight, and degassing under vacuum for about 30 minutes. The silicone was them poured into a nickel motheye template and degassed for about 30 minutes. The entire system was then placed in an oven heated to 50° C. to 60° C. for at least 24 hours. The system was cooled and the silicone template layer was peeled from the Ni template.

The polymer coating was made using thiolene. The thiolene was poured onto a the silicone template layer, and a near UV from a light source to cure the thiolene on the silicone template. The polymer was carefully peeled from the template.

Alternatively, using the same method, after curing the polymer can be applied to a substrate by applying an adhesive to the cured polymer and contacting the adhesive to the substrate. The template and polymer 2-ply laminate can be stretched or flexed to fully cover the substrate before the adhesive contacts the substrate. After contacting and pressing the 2-ply laminate to the substrate, the adhesive can be cured using a UV light source, and the template can be removed after curing. The polymer motheye film should be permanently bonded to the substrate using this method.

By this method, any lens aperture or radius of curvature can be accommodated, without individualized tooling. The films are tough and show durable adhesion.

1. A method for making an imprinted film comprising:
coating a template having a negative pattern of nanostructures with a polymer;
contacting a film and the template; and
curing the polymer to produce the imprinted film.

2. The method of claim 1, wherein the template is a die attached to a drum tool.

3. The method of claim 1, further comprising unwinding the film from a spool of film before contacting the film and the template.

4. The method of claim 1, further comprising washing the film before contacting the film and the template.

5. The method of claim 1, further comprising applying an adhesive to the film before contacting the film and the template.

6. The method of claim 1, further comprising applying a mold release agent to the template before coating the template with the polymer.

7. The method of claim 1, where curing is selected from the group consisting of heating, heating under vacuum, irradiating the polymer, irradiating the polymer with UV light, and combinations thereof.

8. The method of claim 1, further comprising releasing the imprinted film from the template.

9. The method of claim 1, further comprising applying an adhesive to a surface of the imprinted film opposite nanostructures molded from the template.

10. The method of claim 1, further comprising rolling the imprinted film onto a spool.

11. The method of claim 1, wherein the template comprises a flexible mold and contacting the film and the template produces a 2-ply laminate.

12. The method of claim 11, further comprising contacting a substrate with the 2-ply laminate before curing the polymer.

13. The method of claim 11, further comprising contacting a substrate with the 2-ply laminate comprising the imprinted film.

14. The method of claim 13, further comprising applying an adhesive to the substrate, the 2-ply-laminate, or combinations thereof before contacting the substrate with the 2-ply laminate.

15. An imprinted film comprising:
a flexible and stretchable film; and
a polymer layer comprising a plurality of nanostructures attached to at least one surface of the flexible stretchable film.

16. The imprinted film of claim 15, further comprising an adhesive layer disposed between the flexible and stretchable film and the polymer layer.

17. The imprinted film of claim 15, wherein the nanostructures are selected from the group consisting of conical shaped nanostructures, pyramid shaped, trapezoidal shaped nanostructures, truncated pyramid shaped nanostructures, and combinations thereof.

18. The imprinted film of claim 15, wherein each nanostructure individually comprises a height of about 10 nm to about 1000 nm.

19. The imprinted film of claim 15, wherein the plurality of nanostructures have a lateral periodicity of about 1 nanostructure every 10 nm to about 500 nm.

20. The imprinted film of claim 15, wherein each of the flexible and stretchable film and the polymer individually have refractive indices of about 1.3 to about 1.7 over the visible light band.

21. The imprinted film of claim 15, wherein the polymer comprises a material selected from the group consisting silicones, thiolenes, polyurethanes, and combinations thereof.

22. The imprinted film of claim 15, wherein the flexible and stretchable film comprises a material selected from the group consisting silicones, thiolenes, polyurethanes, and combinations thereof.
